(19) United States
(12) Patent Application Publication
(10) Pub. No.: US 2011/0277798 A1
(43) Pub. Date: Nov. 17, 2011

(54) Sample washer for drilling cuttings

(76) Inventor: Donald Thomas Hillier, Powell River (CA)

(21) Appl. No.: 12/662,986

(22) Filed: May 14, 2010

(51) Int. Cl. B08B 3/00

(52) U.S. Cl. 134/135

(57) ABSTRACT

A drill cuttings sample washer according includes a frame-mounted wash bath and degreaser bath. A slide bar is mounted across one end of the frame and adjacent the baths. A spray arm is mounted on the slide bar. Sieve holders are mounted in the baths. A vibrator vibrates at least the degreaser bath. The spray arm is slidably and pivotably mounted on the slide bar. The spray arm pivots for selective raising and lowering of the spray arm from a lowered position over the wash bath to an elevated position allowing access into the bath. Samples contained in mesh-bottomed sample sieves are mountable into each of the sieve holders.

### FIELD OF THE INVENTION

This invention relates to the field of machines for washing drill cutting samples and in particular to a sample washer which provides a unitary system for degreasing and washing and optionally drying such samples.

### BACKGROUND OF THE INVENTION

During the drilling of a well, mud is circulated down hole to carry away drill cuttings and to clean the hole. The cuttings are used by geologists or others to determine the type and characteristics of the drilled strata. In an active mud system, the mud is circulated in a continuous cycle, being, pumped from the drill rig mud tanks, down the hole to the drilling bit, and then returning to surface between the drill pipe and the drill hole wall. The mud brings up the drilling cuttings which are sampled, washed and dried for further analysis and are placed into small plastic vials for both government and oil company use. Rig hands catch the sample material by various means, generally every five meters at specific times. The samples are then delivered to the geologist for further cleaning and analysis. Various types of drilling mud are used today including oil-based mud. Samples drilled with some types of drilling fluids are harder to clean and due to the constantly increasing rates of penetration of the drilling rigs today, any time saved in the cleaning and processing of samples is a benefit to the geologist or person washing samples.

In the prior art, applicant is aware of published United States patent application publication number US2005/0205118 published on Sep. 22, 2005 as filed by Zamfes and entitled Sample Washer for Drilling Cuttings and Other Unconsolidated and Discreet Medias. Zamfes discloses using a container with a liquid supply inlet and processed compound discharge a drum of six dual or more screen assemblies being placed within the container in which a top screen is filled with a sample for washing. Liquid is sprayed into the container from the top in each screen assembly. A micro-vibrator applies mechanical and/or ultrasonic vibrations to the drum and the samples. Air is blown up from underneath and the combination of liquid/air mixture, along with the vibration action, is taught to save washing time and the amount of liquid spent. The drying of the sample is achieved by hot air blowing from underneath and into the sample screen.

### SUMMARY OF THE INVENTION

In summary, a drill cuttings sample washer according to the present invention may be characterized in one aspect as including a pair of frame-mounted baths, a slide bar which is mounted across one end of the frame and adjacent at least one of the baths, a spray arm mounted on the slide bar, sieve holders mounted in the baths, and a vibrator for vibrating at least one of the baths, which advantageously is one, or a pair of, washing baths.

The spray arm may be slidably and pivotably mounted on the slide bar for selective slidable positioning therealong. The spray arm may be oriented substantially perpendicularly to the slide bar. The spray arm pivots for selective raising and lowering of the spray arm between a lowered position directly over one of the baths and an elevated position allowing a user access into the bath. The spray arm is adapted to spray downwardly into the bath when in its lowered position. Mesh-bottomed sample sieves are mountable into each of the sieve holders. The spray arm sprays washing fluid such as hot water, Varsol™ or other solvents or other washing fluids.

A sample dryer may be mounted to, or is mountable to the frame. The sample dryer includes a sieve container for mounting at least one of the sieves therein, and preferably for mounting an aligned stack of sieves therein. The sieve container forms an airflow conduit. A vacuum manifold is mounted in cooperation with the sieve container, for example below it, so as to be in airflow communication with the airflow conduit. An airflow through the sieve container and through the stack of sieves mounted therein is the result of a vacuum applied to the vacuum manifold. The airflow is drawn by the vacuum through the sieve container, through any sieves mounted therein, and into the manifold. The airflow is extracted from the manifold.

Advantageously the sieve container is a hollow vessel sized to receive at least one sample sieve in snug nested mounting therein, and is adapted to hold one or a stack of the sieves substantially horizontal and substantially orthogonal to a flow direction of the air flow. The sieve container may be elongate so that the stack of sieves are mountable therein aligned so that the airflow passes through the mesh-bottom in each sieve in the stack, whereby each sample in each sieve is dried. In one embodiment, where each the sieve is a circular-rimmed dish having a mesh screen bottom, the sieve holders and the sieve container are cylindrical.

In one embodiment the spray arm further includes a spaced apart array of nozzles spaced apart along the spray arm so as to align the nozzles over corresponding sieve holders in the washing baths. Each nozzle may have a shut-off valve mounted thereto for selective spraying of fluid, for example hot water, down onto the corresponding sieve holder.

A draining rack may be provided. The draining rack is adapted to support sample sieves over at least one of the baths for draining and recirculating fluid from the sample sieve back into the corresponding bath. Advantageously that bath is the degreaser bath, and the fluid being recirculated is degreaser fluid.

In one embodiment a substantially planar splash shield or cover, for example of plastic, is mounted substantially horizontally under the spray arm.

### BRIEF DESCRIPTION OF THE DRAWINGS

FIG. 1 is, in plan view, the sample washer according to the present invention.

FIG. 2 is a sectional view along line 2-2 in FIG. 1.

FIG. 3 is, in front elevation, the power control unit of the sample washer of FIG. 1.

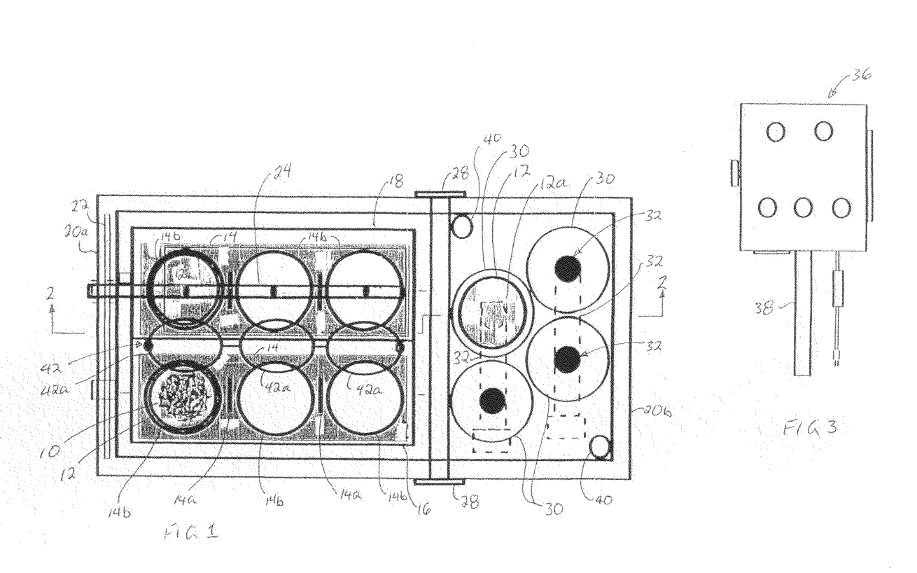

### DETAILED DESCRIPTION OF EMBODIMENTS OF THE INVENTION

As seen in the accompanying drawings wherein like characters of reference denote corresponding parts in each view, the present invention provides a method and apparatus for washing and drying drill cutting samples using a three stage process comprising, for use with oily samples, degreasing a cutting sample in a vibrating degreasing bath, washing the sample under a pressurized spray in a washing bath, and, optionally, drying the samples in a vacuum down-flow air dryer. When the samples are not oily, the degreasing bath may be replaced with a second washing bath.

In the drill cutting sample washer according to a preferred embodiment, drill cutting samples 10, are apportioned into dish-like containers or sieves 12. Sieves 12 are placed into removable sieve holders or trays 14 having lifting handles 14a. Trays 14 are placed in both degreasing bath 16 and washing bath 18. A tray 14 will be moved from the degreasing bath to the washing bath while containing a set of sieves (and samples therein) being washed). In the example illustrated, each removable sieve tray 14 includes apertures or rims 14b sized to snugly hold sieves 12 nested therein. It is understood that although in the illustrated embodiment, each tray 14 holds three sieves, this is not intended to be limiting as it is intended to be within the scope of the present invention to provide baths 16, 18 capable of holding lesser or greater numbers of sieves simultaneously. Advantageously, frame 20 is mounted on resilient feet 20c.

Degreasing bath 16 and washing bath 18 are securely held within frame 20. Baths 16 and 18 may be rigidly mounted to frame 20 or may be removably suspended within the upper opening formed by the upper circumferential frame 20a. Advantageously, as illustrated, baths 16 and 18 are rectangular in plan view and are mounted side-by-side in parallel array, with the longitudinal axis A of bath 16 being parallel to the longitudinal axis B of bath 18, and with the ends of the baths aligned so as to be substantially co-planar.

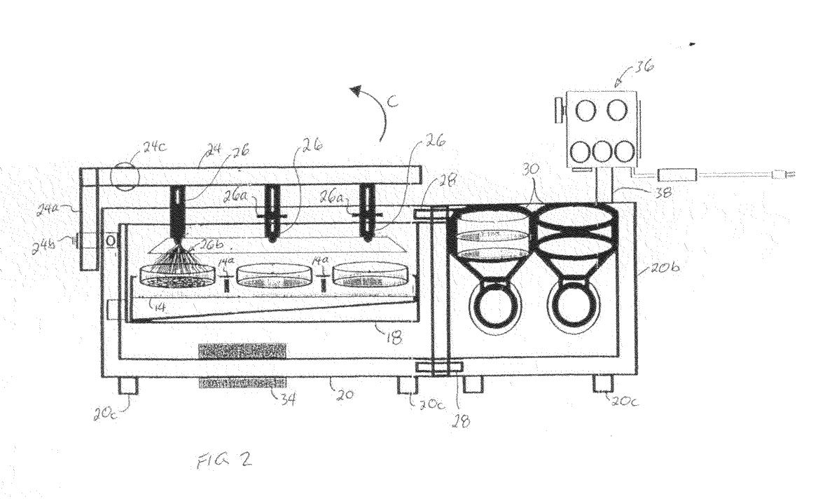

A spray arm slide bar 22 is mounted across the top of frame 20 so as to be parallel to the plane of upper circumferential frame 20 and perpendicular to the longitudinal axes of baths 16 and 18. Spray arm 24 is slidably mounted onto slide bar 22 so as to extend perpendicularly therefrom. Spray arm 24 extends when in its lowered position over at least bath 18 along the length thereof. Spray arm 24 is pivotably mounted onto slide bar 22, for example by means of an adjustable mounting bracket 24a. Bracket 24a includes an adjustment screw 24b for adjusting the position of spray arm 24 over bath 18. Spray arm 24 may be also include spray nozzles 26 which are mounted to the underside of the spray arm so as to be downwardly oriented when spray arm 24 is in its lowered position such as seen in FIG. 2. Fluid for example such as pressurized hot water supplied through a hose line (not shown) attached to spray arm 24 at hose attachment 24c, flows along the spray arm through a conduit (not shown) to feed into each spray nozzle 26. Each spray nozzle 26 has a shut off valve controlled by for example a manually actuable on/off lever 26a. A user may manually control the flow actuation and volume of flow impinging each sample 10 within bath 18 with the fluid spray 26b from nozzles 26 by shutting off the fluid flow by closing levers 26a. Spray arm 24 may be rotated upwardly in direction C about slide bar 22 so as to remove the spray arm 24 from the upper opening into frame 20a to thereby allow a user access to washing bath 18.

In a preferred embodiment, slide bar 22 extends laterally entirely across upper frame 20a so that, in the event that samples 10 do not require a degreasing bath 16, a second washing bath 18 may be substituted for degreasing bath 16 or degreasing bath 16 may be converted for use as a washing bath 18, and a second spray arm 24 may then be mounted onto slide bar 22 so that both washing baths 18 may be simultaneously sprayed. Thus sieves 12 mounted in trays 14 in both washing baths may be simultaneously sprayed so as to wash samples 10 therein.

A dryer frame 20b may optionally be mounted to frame 20 for example at the end of frame 20 opposite to slide bar 22 by means of for example mounting brackets or clamps 28. Drying stands 30 are mounted within frame 20b. Drying stands 30 cooperate with vacuum manifolds 32. Drying stands 30 may be vertically aligned cylinders as illustrated or otherwise be hollow containers shaped to snugly receive nested therein a stack of sieves 12. Where sieves 12 are, as illustrated, circular, then drying stands are cylindrical so that, with a vertically stacked array of sieves 12 mounted in drying stands 30, a vacuum applied to vacuum manifold 32 draws airflow downwardly in direction D through the mesh 12a in each sieve 12. Advantageously the bottom screens of sieves 12 are of brass 60 mesh. The airflow dries samples 10 contained on the mesh. Although in the illustration two sieves 12 are shown stacked within a drying stand 30, it is not intended that the present invention be so limited as more sieves 12 could be simultaneously dried in a drying stand 30 if the drying stand 30 was sufficiently sized.

A mechanical vibrator 34 including for example an off-centered weight mounted to an electric motor, may be mounted to frame 20. Vibrator 34 may be mounted along a lower member thereof underneath degreasing bath 16 as illustrated, or without intending to be limiting, may be mounted directly to degreasing bath 16. In embodiments where vibrator 34 is electrically powered, vibrator 34 may be provided power from a power unit 36 mounted for example on a post 38 slid downwardly into a snugly fitting collar 40 rigidly mounted to frame 20. Power unit 36 provides switching to control shut off of vibrator 34 and also controls the intensity of the vibration, for example by controlling the frequency of the revolutions of the off-centre weight within vibrator 34.

In one embodiment, a draining rack 42 is removably mounted between, so as to suspend the rack over, one or both of baths 16 and 18. The rack may, as illustrated, include a series of rings sized to snugly hold therein sieves 12. Thus sieves 12 once removed from, for example, degreasing bath 16 may be placed into the rings 42a of rack 42 so as to drain degreasing fluid back into bath 16. Advantageously, rings 42a are tilted or may be selectively rotated from a horizontal position to tilted position so as to incline sieves 12 downwardly towards the bath into which it is desired to drain and recapture the fluid from the sieves. In this fashion degreasing fluid may be recaptured by draining from sieves 12 prior to drying of the sieves within drying stands 30.

Splash shield 44 may be provided mounted under spray arm 24.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A drill cuttings sample washer comprising:
a frame,
first and seconds baths mounted in said frame,
a slide bar mounted across one end of said frame and adjacent at least one of said baths,
a spray arm slidably and pivotably mounted on said slide bar for selective slidable positioning therealong, said spray arm oriented substantially perpendicularly to said slide bar, said spray arm pivotable about said slide arm for selective raising and lowering of said spray arm between a lowered position directly over said at least one of said baths and an elevated position allowing a user access into said at least one of said baths, wherein said spray arm is adapted to spray downwardly into said at least one of said baths when in said lowered position,
at least one sieve holder mounted in each of said first and second baths, at least one mesh bottomed sample sieve mountable into each of said at least one sieve holder,
a vibrator mounted to one of either said frame or said at least one of said baths.

2. The sample washer of claim 1 further comprising a sample dryer mountable to said frame, said sample dryer comprising a sieve container for mounting at least one of said sieves therein, said sieve container forming an airflow conduit, a vacuum manifold mounted in cooperation with said sieve container so as to be in airflow communication with said airflow conduit wherein an airflow through said sieve container results from a vacuum applied to said vacuum manifold whereby the airflow is drawn through said sieve container and through any said mesh-bottomed sample sieves mounted therein.

3. The sample washer of claim 2 wherein said sieve container is adapted to hold said sieves substantially horizontal and substantially orthogonal to a flow direction of said air flow.

4. The sample washer of claim 3 wherein said sieve container is a hollow vessel sized to receive at least one said sample sieve in snug nested mounting therein.

5. The sample container of claim 4 wherein said sieve container is elongate so that a stack of said sample sieves are mountable therein aligned so that said airflow passes through each said mesh-bottomed sample sieve in said stack whereby each sample in each said sieve is dried.

6. The sample washer of claim 5 wherein each said sieve is a circular-rimmed dish having a mesh screen bottom, and wherein said at least one sieve holder and said sieve container are cylindrical.

7. The sample washer of claim 1 wherein said spray arm further comprises a spaced apart array of nozzles spaced apart along said spray arm so as to align at least one nozzle of said array of nozzles over a corresponding sieve holder of said at least one sieve holder.

8. The sample washer of claim 7 wherein each said nozzle has a shut-off valve mounted thereto for selective spraying of fluid down onto said corresponding sieve holder.

9. The sample washer of claim 1 further comprising a draining rack, said draining rack adapted to support said sample sieves over said at least one of said baths for recirculating a fluid-to-be-drained from said sample sieve back into one bath of said at least one of said baths.

10. The sample washer of claim 9 wherein said one bath is a degreaser bath and said fluid-to-be-drained is degreaser fluid.

11. The sample washer of claim 10 wherein said first bath is said degreaser bath and wherein said second bath is a wash bath, and wherein said spray arm is slidably mounted adjacent to, and pivotable over, at least said wash bath.
